(19) United States
(12) Patent Application Publication
(10) Pub. No.: US 2009/0115926 A1
(43) Pub. Date: May 7, 2009

(54) DISPLAY AND METHOD OF MAKING

(76) Inventors: Seong Choon Lim, Penang (MY); Eit Thian Yap, Penang (MY); Wei Liam Loo, Penang (MY)

Correspondence Address: Kathy Manke;Avago Technologies Limited, 4380 Ziegler Road, Fort Collins, CO, 80525, US

(21) Appl. No.: 11/935,173

(22) Filed: Nov. 5, 2007

(51) Int. Cl. G02F 1/136

(52) U.S. Cl. 349/44; 345/33

(57) ABSTRACT

Displays and methods of manufacturing displays are disclosed herein. An embodiment of a method of manufacturing a display comprises manufacturing a circuit board; forming a hole in a material; attaching the circuit board to the material, wherein the hole forms a cavity upon attachment of the circuit board to the material; and connecting a light source to the circuit board, the light source being located within the cavity.

### BACKGROUND

Light emitting diodes are used in many different applications. One such application are segment displays, such as seven segment displays. Due to construction techniques, the displays tend to be rather high, meaning that they extend rather high from the circuit board or substrate on which they are mounted. Many electronic devices that segment displays are becoming smaller, but the size is limited by the relatively large height of the segment displays.

### BRIEF DESCRIPTION OF THE DRAWINGS

FIG. 1 is a top plan view of an embodiment of a display.

FIG. 2 is a top plan view of an embodiment of a digit used in the display of FIG. 1.

FIG. 3 is a cut away view of an embodiment of the segment display of FIG. 1.

### DETAILED DESCRIPTION

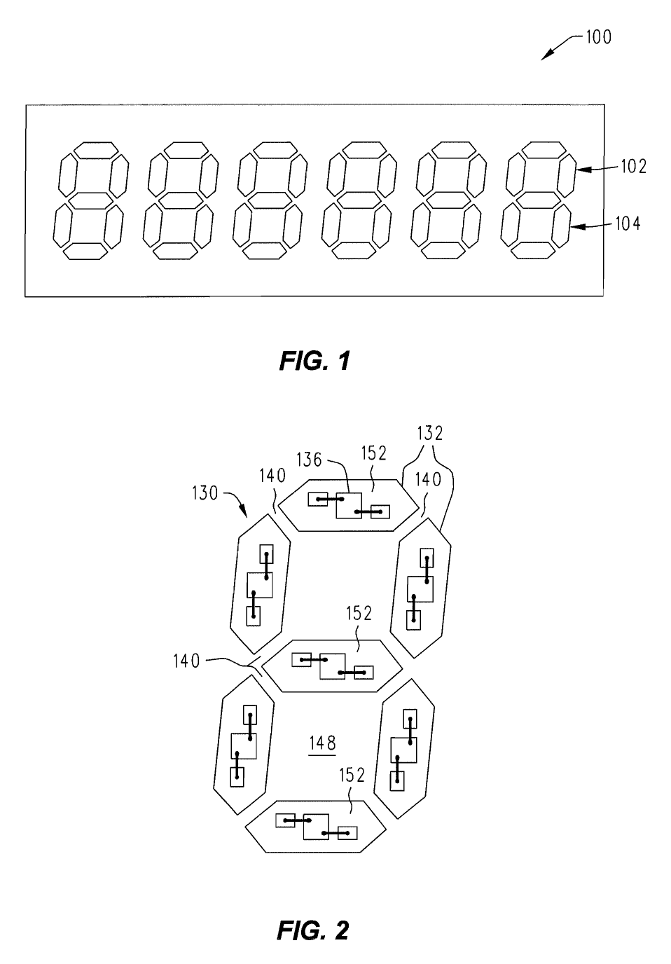

Segment displays and methods of making segment displays are disclosed herein. FIG. 1 is a top plan view of an embodiment of a display 100. The display 100 described herein is a six digit, seven segment display; meaning that the display 100 has six digits 102 and digit has seven segments 104. It is to be understood that the display 100 described herein is for exemplary purposes only and that other display formats may be used.

Each digit has seven segments 104, which enable all numerals to be displayed. As described in greater detail below, each of the segments 104 includes a cavity that has a light source, such as an light-emitting diode, located therein. When the light source emits light, the light is reflected so that the cavity or segment emits light in the shape of the cavity. Conventional displays cut the cavities into the substrate, which is difficult, especially as the size of the substrate decreases.

FIG. 2 is a top plan view of a digit 130 as used in the display 100 of FIG. 1. The digit 130 has a plurality of segments 132. The embodiment of the digit 130 has seven segments 132. As described in greater detail below, the segments 132 are cavities within the display 100, of FIG. 1. Each segment 132 has a light source 136 located within the cavity. The light sources 136 may be a light-emitting diodes (LEDs) and are sometimes referred to as LEDs 136. Separation walls 140 are located between the segments 132. The separation walls 140 serve to isolate the segments 132 to prevent light from a first segment from entering a second segment. By selectively lighting individual light sources 136, different numbers or letters can be displayed in a conventional manner.

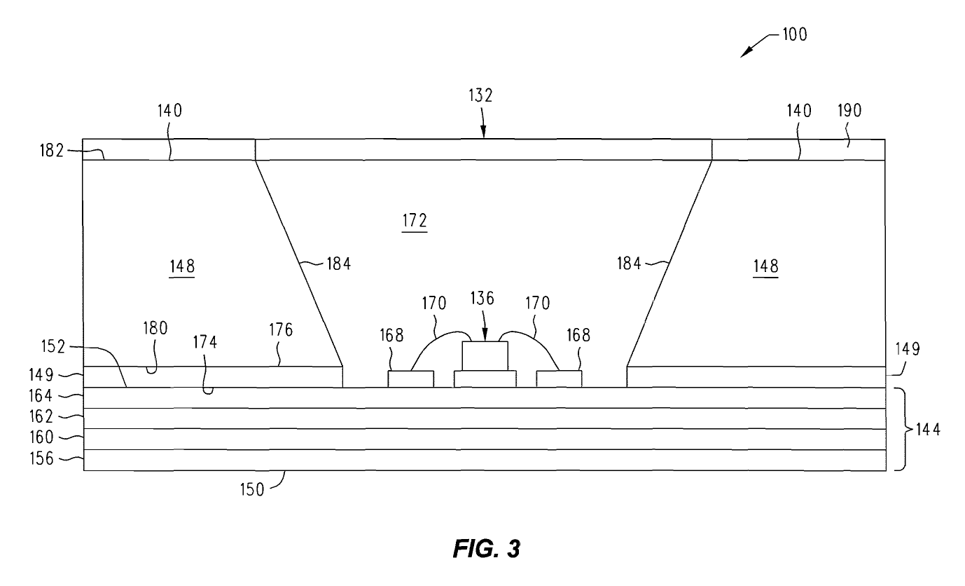

FIG. 3 is a side cut away view of an embodiment of a segment display 100. The embodiment of the display 100 includes a circuit board 144 and a material 148 attached to the circuit board 144. In some embodiments an adhesive film 149 is located between the circuit board 144 and the material 148 and serves to attach the material 148 to the circuit board 144.

The circuit board 144 may be a rigid-type or flexible-type circuit board. The circuit board 144 has a first side 150 and a second side 152 located opposite the first side 150. The first side 150 may serve as an exterior surface for the display 100. The second side 152 is located proximate the material 148. Electronic traces and the like are located on or within the circuit board 144. For example, electronic traces may be located on the second side 152 of the circuit board 144. The electronic traces serve to connect electronic components mounted to the circuit board 144 and the transmit signals throughout the circuit board 144. In the embodiment of the circuit board 144 described herein, the circuit board 144 serves to provide electricity to at least one light source 136, such as an LED (referred to herein as the LED 136), connected to the circuit board 144.

The embodiment of the circuit board 144 described herein has four layers as described below. A first layer 156 may be a solder mask or other non-conductive material. The first layer 156 serves as an insulator and covering for the display 100. A second layer 160 may contain electrically conductive elements, such as traces and vias. The traces in the second layer 160 may serve to power the LED 136. In an alternative embodiment, the second layer 160 may be a continuous conductive sheet and may serve as a ground plane.

A third layer 162 may be an insulator, such as a polymide, or any other insulator used in printed circuit board fabrication. A fourth layer 164 may contain electrical elements, such as traces, and may work with the second layer 162 to provide power to the LED 136. The first side 150 of the circuit board 144 is located on the first layer 156 and the second side 152 of the circuit board 144 is located on the fourth layer 164.

The fourth layer 164 also may have conductive pads 168 located thereon. The pads 168 may be made, as examples, of copper, aluminum, or nickle. Wires 170 connect the pads 168 to the LED 136. The pads 168 may be placed on specific traces on the fourth layer 164 in order to conduct electricity to the LED 136. As shown, the LED 136 is located in a cavity 172. As described below, the cavity 172 forms the seven segments 132.

As stated above, some embodiments of the display 100 may use an adhesive film 149 to connect the circuit board 144 to the material 148. The adhesive film 149 may also be referred to as a bonding film. The adhesive film 149 has a first side 174 and a second side 176 located opposite the first side 174. The first side 174 of the adhesive film 149 is attached to the second side 152 of the circuit board 144. In some embodiments, the first side 174 of the adhesive film comprises an adhesive and is adhered to the second side 152 of the circuit board 144. In some embodiments, an adhesive may be applied to the second side 152 of the circuit board 144 or the first side 174 of the adhesive film and the adhesive 149 film may be subsequently adhered to the circuit board 144.

As described in greater detail below, the adhesive film 149 may have portions cut out so that the adhesive film 149 does not cover the pads 168, the LED 136, the wires 170, or other contacts requiring electrical connections. In other embodiments, the adhesive film 149 may be a continuous sheet. Portions may be cut out of the continuous sheet in order to enable electrical connections to be made as required.

The material 148 may comprise pre-molded polyphthalamide, liquid crystal polymer, FR-4, polyethene (PET) or other materials. In some embodiments, the material 148 is rigid and may be more rigid than the circuit board 144. In some embodiments, the material 148 may be able to withstand high temperature, such as the temperature required to bond or solder components to the circuit board 144.

The material 148 has a first side 180 and a second side 182. The first side 180 of the material 148 is located adjacent the second side 152 of the circuit board 144. In embodiments using the adhesive film 149, the adhesive film 149 may be adhered to the second side 152 of the circuit board 144 and the first side 180 of the material 148. With additional reference to FIG. 2, the material 148 has cavities 172 formed therein that form the segments 132. In the embodiment described herein, the cavities 172 extend between the first side 180 and the second side 182 and may be through holes. The cavities 172 may be virtually any shape and may be formed by drilling, die-set punch, or other methods. When the material 148 is adhered to the adhesive film 149, the cavities 172 become the segments 132 of the display 100.

With additional reference to FIG. 2, the cavity 172 is shaped as the segment 132. Therefore, when the LED 136 illuminates, the segment 132 illuminates. In order to direct light from the cavity 172, the material 148 has walls 184 that may reflect light. The reflection also serves to increase the intensity of light emitted from the cavity 172. The angle in which the walls 184 intersect the circuit board 144 affects the illumination provided by the display 100. In some embodiments, the walls 184 intersect the circuit board 144 at a certain angle e.g. a forty-five degree angle. The material 148 and the walls 184 serve as the separation walls 140 between the segments 132.

The cavity 172 may be filled with an encapsulant. The encapsulant serves to protect the components located within the cavity 172. In addition, the encapsulant may serve to diffuse the light emitted by the LED 136. The diffusion evens the light emission from the cavity 172 so that all areas of the cavity 172 emit approximately the same intensity of light. A cover 190 may be placed over the cavity 172 and may adhere to the second side 182 of the material 148. The portion of the cover 190 covering the cavity 172 may serve to further diffuse light emitted by the LED 136. The portion of the cover 190 covering the material 148 may be a color that contrasts with the color of light emitted by the segments 132 so that the display 100 is easier to read.

Fabrication of the display 100 consists of fabricating the circuit board 144 as described above. The material 148 is fabricated with holes in locations of the cavities 172. The material 148 is then attached to the circuit board 144. In some embodiments, the adhesive film 149 is used to adhere the material 148 to the circuit board 144. In some embodiments, the adhesive film 149 is a continuous sheet and portions of the sheet proximate the cavities 172 are removed. In other embodiments, the adhesive film 149 is cut to fit the first side 180 of the material 148, so no material needs to be removed after the material 148 is adhered to the circuit board 144. The holes in the material 148 become cavities when the material 148 is attached to the circuit board 144.

The LED 136 and wires 170 may be connected to the circuit board 144 before or after the material 148 is bonded to the circuit board 144. After the material 148 is bonded to the circuit board 144, the encapsulant may be added to the cavity 172. The cover 190 may then be added. Colors may be added to the cover 190 before or after it is attached to the material 148.

The display 100 described herein may be a very thin display. For example, the thickness of the display 100 between the cover 190 and the first surface 150 of the circuit board 144 may be approximately 0.6 millimeters or less. One reason for the thin display is the use of the material 148, wherein holes are precut into the material 148, so that cavities do not have to be cut after the material 148 is attached to the circuit board 144.

What is claimed is:

1. A method of manufacturing a display, said method comprising:
manufacturing a circuit board;
forming a hole in a material;
attaching said circuit board to said material, wherein said hole forms a cavity upon attachment of said circuit board to said material; and
connecting a light source to said circuit board, said light source being located within said cavity.

2. The method of claim 1, wherein said attaching comprises attaching an adhesive sheet to said circuit board, wherein said adhesive sheet has a first side facing said circuit board and a second side located opposite said first side, said second side being adhesive, said second side adhering to said material.

3. The method of claim 2, wherein said first side of said adhesive film is adhesive, and wherein said attaching comprises adhering said first side of said adhesive film to said circuit board.

4. The method of claim 1, wherein said circuit board is a flexible circuit board.

5. The method of claim 1, wherein said material comprises polyphthalamide.

6. The method of claim 1, wherein said material comprises liquid crystal polymer.

7. The method of claim 1, wherein said material comprises FR-4.

8. The method of claim 1, wherein said material comprises polyethene.

9. The method of claim 1, wherein said forming said hole comprises drilling said hole.

10. The method of claim 1, wherein said forming said hole comprises die-set punching said hole.

11. The method of claim 1, wherein said circuit board has at least one electrical trace located thereon, and wherein at least a portion of said at least one electrical trace is located in said cavity.

12. The method of claim 1, wherein said forming a hole comprises inclining at least one wall of said hole.

13. The method of claim 1, wherein said forming a hole further comprises forming a hole, wherein a wall of said hole reflects light emitted by said light source.

14. A display comprising:
a circuit board;
a material with at least one hole formed therein, wherein said material is attached to said circuit board, said hole forming a cavity when said material is attached to said circuit board; and
a light source connected to said circuit board, said light source being located within said cavity.

15. The display of claim 14 and further comprising an adhesive film attached to said circuit board, wherein said adhesive film has a first side facing said circuit board and a second side located opposite said first side, said second side being adhered to said material.

16. The display of claim 15, wherein said first side of said adhesive film is adhesive, and wherein said first side of said adhesive film is adhered to said circuit board.

17. The display of claim 14, wherein said circuit board is a flexible circuit board.

18. The display of claim 14, wherein said material comprises polyphthalamide.

19. The display of claim 14, wherein said material comprises liquid crystal polymer.

20. The display of claim 14, wherein said material comprises FR-4.

21. The display of claim 14, wherein said material comprises polyethene.

22. The display of claim 14, wherein said hole comprises a die-set punched hole.

23. The display of claim 14, wherein the height of said display is less than 0.6 millimeters.
